(19) United States
(12) Patent Application Publication
(10) Pub. No.: US 2024/0046701 A1
(43) Pub. Date: Feb. 8, 2024

(54) IMAGE-BASED POSE ESTIMATION AND ACTION DETECTION METHOD AND APPARATUS

(71) Applicant: MARKANY INC., Seoul (KR)

(72) Inventors: Min Seong PARK, Anyang-si (KR); Chang Dae SON, Seoul (KR); Si Ye JANG, Seoul (KR); Ji In NAM, Seoul (KR)

(73) Assignee: MARKANY INC., Seoul (KR)

(21) Appl. No.: 18/088,676

(22) Filed: Dec. 26, 2022

(30) Foreign Application Priority Data
Aug. 5, 2022 (KR) 10-2022-0097852

(51) Int. Cl. G06V 40/20; G06V 20/52; H04N 7/18; G06V 10/82

(52) U.S. Cl. CPC G06V 40/20; G06V 20/52; H04N 7/183; G06V 10/82; G08B 13/19613

(57) ABSTRACT

The present disclosure relates to a method of identifying a posture and detecting a specific behavior based on artificial intelligence. A method of detecting an abnormal behavior in a video based on a computational device according to an embodiment of the present disclosure may involve obtaining at least one video frame; obtaining at least one piece of human posture information from a first artificial intelligence based on the obtained video frame; obtaining information on whether an abnormal behavior has been detected and at least one piece of abnormal behavior information from a second artificial intelligence based on at least one piece of human posture information obtained in chronological order; and marking the at least one video frame based on the information on whether an abnormal behavior has been detected and the at least one piece of abnormal behavior information.

### CROSS-REFERENCE TO RELATED APPLICATIONS

This application claims the benefit of priority of Korean Patent Application No. 10-2022-0097852 filed on Aug. 5, 2022, which is incorporated by reference in their entirety herein.

### ACKNOWLEDGEMENT

This work was supported by Institute for Information & communications Technology Promotion (IITP) grant funded by the Government of the Republic of Korea, Ministry of Science and ICT (MSIT) (No. 1711152654, 2021-0-00348-002, Development of A Cloud-based Video Surveillance System for Unmanned Store Environments using Integrated 2D/3D Video Analysis).

### FIELD

### Background

The present disclosure relates to a method of identifying a posture and detecting a specific behavior based on artificial intelligence, and, specifically, to a combination of artificial intelligence for identifying a posture and artificial intelligence for detecting a specific behavior and an organization of learning data for detecting a specific behavior.

### Related Art

When performing security surveillance by a video surveillance equipment such as CCTV cameras or drone cameras, the CCTV controller is responsible for determining whether a person showing any abnormal behavior warranting action has been filmed in a specific surveillance area. However, since one controller generally has to monitor videos taken by 150 to 200 cameras, it is not possible to continuously concentrate on monitoring the multiple videos, resulting in a problem of lowering the accuracy of the determination. In order to solve this problem, there has been a demand for a technology where artificial intelligence first detects an abnormal behavior in a surveillance video, if any, and a controller is requested to make a determination only on the video in which the abnormal behavior has been detected. Accordingly, in recent years, in the field of computer vision, the technology for video-based detection of abnormal event has been widely developed and attracted attention.

Examples of an abnormal behavior to be detected include intrusion, loitering, falling down, theft, smoking, violence, etc. Among them, the violence detection is gaining increasing attention due to the increase in the crime rate in society. The technology for automated violence detection can be applied in a variety of environments. For example, it can be used for early detection of signs of violence between inmates in correctional facilities or crime prevention and countermeasures in markets, convenience stores, and public institutions.

### SUMMARY

In the existing technology for detecting an abnormal behavior using computer vision based on artificial intelligence, in order to detect specific abnormal behaviors in a video, an object is identified, the type, size, etc. of the object is then obtained by the artificial intelligence, and it is compared with the previously learned data to determine whether it falls within the specific abnormal behaviors.

However, in this method, since artificial intelligence is learned based on indirect criteria that are not directly related to a human behavior itself, the accuracy of detection cannot be sufficiently guaranteed.

In order to solve the above-mentioned problem, a method of detecting an abnormal behavior in a video based on a computational device according to an embodiment of the present disclosure may involve obtaining at least one video frame; obtaining at least one piece of human posture information from a first artificial intelligence based on the obtained video frame; obtaining information on whether an abnormal behavior has been detected and at least one piece of abnormal behavior information from a second artificial intelligence based on at least one piece of human posture information obtained in chronological order; and marking the at least one video frame based on the information on whether an abnormal behavior has been detected and the at least one piece of abnormal behavior information.

The method may further involve generating alarming information on the abnormal behavior based on the marking (the alarming information includes at least one of information on a route through which the video frame was acquired, information on the type of the abnormal behavior, and information on the spatial location of the abnormal behavior in the video frame) and transmitting the alarming information to a user's terminal.

The video frame may be taken by a filming equipment including a fixed surveillance camera and a mobile surveillance camera, and the information on the route through which the video frame was acquired may include at least one of a unique identifier of the filming equipment, a time at which the video frame was captured, and the geographical location of the filming equipment.

The human posture information may include at least one piece of human joint information and at least one piece of joint direction information.

The human joint information may be about at least one of the face, neck, right shoulder, right elbow, right wrist, left shoulder, left elbow, left wrist, right pelvis, right knee, right ankle, left pelvis, left knee, and left ankle.

The human joint information may not include information on joints related to facial expressions, including the right eye, left eye, right ear, and left ear.

The first artificial intelligence may be designed to receive the video frame, generate the at least one piece of human joint information and the at least one piece of joint direction information based on the video frame, and generate the human posture information by combining the at least one piece of human joint information and the at least one piece of joint direction information.

The second artificial intelligence may be designed to receive the at least one piece of human posture information that is temporally continuous, obtain at least one feature value of an abnormal behavior based on the at least one piece of human posture information, and obtain at least one piece of the information on whether an abnormal behavior has been detected and the abnormal behavior information based on the at least one feature value of the abnormal behavior.

The second artificial intelligence may be formed of a long-short-term memory-based neural network based on convolution, may combine the at least one feature value of an abnormal behavior based on a convolution operation, and may obtain the information on whether an abnormal behavior has been detected and the abnormal behavior information based on the result of adaptive average pooling on the combined values.

The second artificial intelligence may be designed to obtain information on whether at least one of intrusion, loitering, falling down, theft, smoking, and violence has been detected and information on the abnormal behavior.

In order to solve the above-mentioned problem, a video security monitoring device may include a video capturing unit for acquiring at least one video frame, a first artificial intelligence calculator for obtaining at least one piece of human posture information based on the obtained video frame, a second artificial intelligence calculator for obtaining information on whether an abnormal behavior has been detected and at least one piece of abnormal behavior information based on at least one piece of human posture information obtained in chronological order, and a marking unit for marking the at least one video frame based on the information on whether an abnormal behavior has been detected and the at least one piece of abnormal behavior information.

The device may generate alarming information including at least one of information on a route through which the at least one video frame was acquired, information on the type of the abnormal behavior, and information on the spatial location of the abnormal behavior in the video frame, based on the marking, and may further include an alarming unit forwarding the alarming information to the manager responsible for dealing with abnormal behaviors.

The video capturing unit may acquire a video frame by being connected to a filming equipment including a fixed surveillance camera and a mobile surveillance camera, and the information on the route through which the video frame was acquired may include at least one of a unique identifier of the filming equipment, a time at which the video frame was captured, and the geographical location of the filming equipment.

The human posture information may include at least one piece of human joint information and at least one piece of joint direction information.

The human joint information may be about at least one of the face, neck, right shoulder, right elbow, right wrist, left shoulder, left elbow, left wrist, right pelvis, right knee, right ankle, left pelvis, left knee, and left ankle.

The human joint information may not include information on joints related to facial expressions, including the right eye, left eye, right ear, and left ear.

The first artificial intelligence calculator may include a first machine learning model that receives the video frame, generates the at least one piece of human joint information and the at least one piece of joint direction information based on the video frame, and generates the human posture information by combining the at least one piece of human joint information and the at least one piece of joint direction information.

The second artificial intelligence calculator may include a second machine learning model that receives the at least one piece of human posture information that is temporally continuous, obtains a feature value of an abnormal behavior based on the at least one piece of human posture information, and obtains the information on whether an abnormal behavior has been detected and the abnormal behavior information based on the feature value of the abnormal behavior.

The second machine learning model may be formed of a long-short-term memory-based neural network based on convolution, may combine at least one feature value of the abnormal behavior based on a convolution operation, and may obtain the information on whether an abnormal behavior has been detected and the abnormal behavior information based on the result of adaptive average pooling on the combined values.

The second machine learning model may be designed to obtain information on whether at least one of intrusion, loitering, falling down, theft, smoking, and violence has been detected and information on the abnormal behavior.

When specific actions are detected in videos by applying a technology for identifying a posture through which it may possible to precisely examine the position and movements of a human body, the accuracy of the detection may be further improved. In particular, since abnormal behaviors inevitably involve a change in posture following their distinct motions, it may be possible to further improve the accuracy of detection by producing artificial intelligence that detects abnormal behaviors by being trained based on posture information.

### BRIEF DESCRIPTION OF THE DRAWINGS

FIG. 1 is a conceptual view of a process of detecting an abnormal behavior according to an embodiment of the present disclosure.

FIG. 2 is a flowchart illustrating the process of detecting an abnormal behavior according to an embodiment of the present disclosure.

FIG. 3 is a conceptual view of a process of obtaining human posture information according to an embodiment of the present disclosure.

FIG. 4 is a conceptual view of a process of analyzing temporally continuous posture information by a convolutional long-short-term memory (ConvLSTM).

FIG. 5 is a block diagram showing the feature of a video monitoring device according to an embodiment of the present disclosure.

### DESCRIPTION OF EXEMPLARY EMBODIMENTS

Since various modifications and embodiments of the present disclosure are possible, specific embodiments thereof will be illustrated in the appended drawings and described in detail. However, this is not intended to limit the present disclosure to the specific embodiments, and it should be understood that all modifications, equivalents, and substitutes falling within the technology and the scope of the present disclosure are included.

Expressions such as “first” and “second” may be used to describe various components, but the components should not be limited by the terms. The expressions are only used for the purpose of distinguishing one component from another. For example, a first component may be termed a second component, and, similarly, the second component may be termed the first component within the scope of the present disclosure. The expression “and/or” means that any combination of a plurality of related items or any of the plurality of related items is included, and has a non-exclusive meaning unless indicated otherwise. Where items are listed in the present disclosure, it is merely to provide examples to facilitate describing the technology and possible embodiments of the present disclosure, so it is not intended to limit the scope of the embodiments of the present disclosure.

When a component is described as “connected” to another component, it should be understood that the component may be directly connected to the other component or another component may be present therebetween. On the other hand, when a component is described as “directly connected” to another component, it should be understood that no other component exists therebetween.

Terms used in the present disclosure are only used to describe specific embodiments, and are not intended to limit the present disclosure. Expressions in the singular form include the meaning of the plural form unless they clearly mean otherwise in the context. In the present disclosure, expressions such as “include” or “have” are intended to indicate the existence of features, numbers, steps, operations, components, parts, or combinations thereof described in this specification, but are not intended to exclude in advance the existence or the possible addition of one or more other features, numbers, steps, operations, components, parts, or combinations thereof.

Unless defined otherwise, all terms used herein, including technical or scientific terms, have meanings generally understood by a person having ordinary skill in the technical field to which the present disclosure belongs. Terms defined in commonly used dictionaries should be interpreted as having the meanings that they have in context in the related technology, and should not be construed in an idealized or overly formal sense unless explicitly defined in the present disclosure.

In describing the present disclosure, embodiments may be described or exemplified in terms of described functions or unit blocks that perform the functions. The blocks may be expressed as one or multiple devices, units, modules, parts, etc. in the present disclosure. The blocks may be operated in hardware by one or multiple logic gates, integrated circuits, processors, controllers, memories, electronic components, or methods of operating information processing hardware, which are not limited thereto. Alternatively, the blocks may also be operated in software by a method of operating application software, operating system software, firmware, or information processing software not limited thereto. A single block may be divided into a plurality of blocks performing the same function to be operated, or, conversely, a single block may be operated to simultaneously perform the functions of the plurality of blocks. The blocks may also be physically separated or combined according to an arbitrary criterion. The blocks may operate in an environment in which their physical locations are not specified by a communication network, the Internet, a cloud service, or a communication method not limited thereto and are spaced apart from each other. Since all of the above-mentioned operating methods are within the scope of various embodiments that can be taken by a person having ordinary skill in the field of information and communication technology to implement the same technology, they should be construed as falling within the scope of the technology of the present disclosure.

Hereinafter, with reference to the accompanying drawings, the desirable embodiments of the present disclosure will be described in more detail. In describing the present disclosure, to facilitate understanding the overall disclosure, a consistent reference numeral will be used for a certain component in the drawings, and a description of the same components will not be repeatedly provided. It is also assumed that a plurality of embodiments may not be mutually exclusive and that some embodiments may be combined with one or more other embodiments to form new embodiments.

According to the present disclosure, there may be provided a method of detecting abnormal behaviors in images using a computer device and a device devised by the same. More specifically, according to the present disclosure, there may be provided a method of detecting various types of abnormal behaviors in videos obtained by a camera, etc. and providing a signal and an alarm about the detection result, and a device for implementing the method.

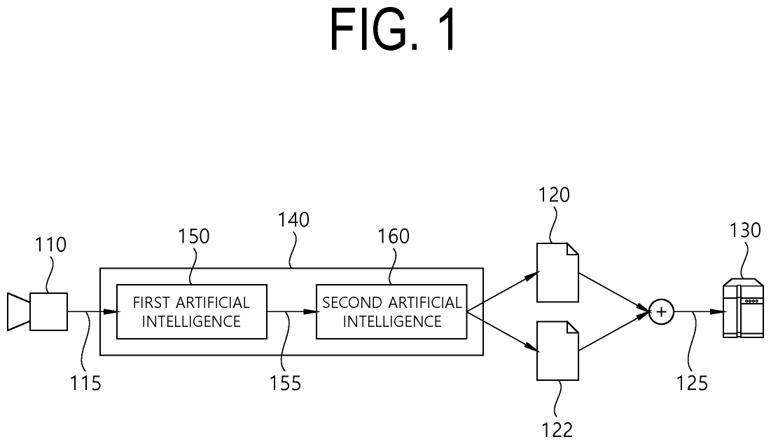

FIG. 1 is a conceptual view of a process of detecting an abnormal behavior according to the present disclosure. The present disclosure as a whole may be described as a process of outputting information indicating whether an abnormal behavior is detected in a video section per unit time 120 and the type 122 of the abnormal behavior by receiving a video 115 from a video source 110 and going through a process 140 of detecting an abnormal behavior. The video source 110 may be a fixed or movable surveillance camera such as a CCTV camera installed indoors or outdoors or a camera installed in a surveillance drone, an unmanned vehicle, etc. In addition, the information on whether an abnormal behavior is detected 120 and the type 122 of the abnormal behavior may be included in alarm information 125 and transmitted to a user's terminal 130.

That is, according to an embodiment of the present disclosure, the present disclosure may be carried out in a CCTV control room with a controller monitoring a plurality of CCTV cameras simultaneously to be used to implement a so-called “smart CCTV” in which a controller is alerted when a predetermined abnormal behavior occurs on a screen captured by a specific CCTV camera so that the controller can take note thereof.

The process 140 of detecting an abnormal behavior may include a first artificial intelligence 150 and a second artificial intelligence 160 as detailed components.

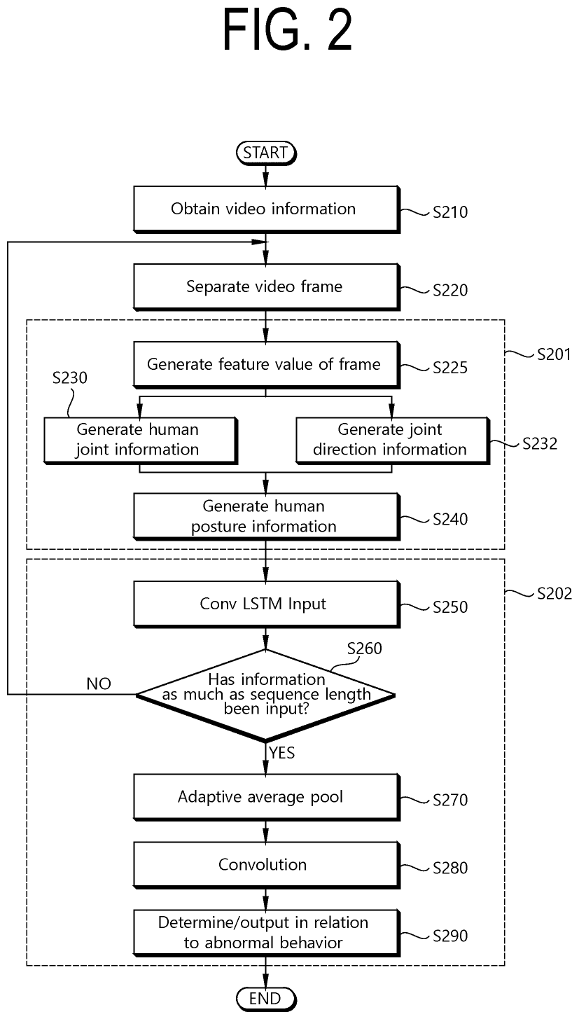

FIG. 2 is a flowchart illustrating the process of detecting an abnormal behavior according to an embodiment of the present disclosure. In order to detect an abnormal behavior, as described above, video information taken by a filming equipment including a fixed surveillance camera and a mobile surveillance camera may be obtained at S210. The video information may include video data consisting of at least one video frame, and may also include information on a route where the video data was obtained. The information on the acquisition route may be, for example, information for specifying a filming equipment that has been used to obtain the video information. The information for specifying the filming equipment may include, for example, at least one of a unique identifier of the filming equipment, a time at which the video frame was captured, and a geographical location of the filming equipment. In other words, according to an embodiment of the present disclosure described above, the information on the acquisition route may be information for indicating a shooting time point of a specific CCTV camera, and may correspond to information in which a shooting time is combined with information indicating an ID for managing a specific CCTV, information on an address of the specific CCTV, information on latitude/longitude indicating the location of the specific CCTV, etc.

At least one video frame separated from the obtained video information may be acquired at S220. As for the standard of typical digital video data, a continuous video may consist of a predetermined number of video frames arranged in chronological order. Each of the video frames may be separated and used as processing data for an operation for detecting an abnormal behavior according to the present disclosure.

The obtained video frame may be used for a process (S201) by the first artificial intelligence. The first artificial intelligence may have a function of acquiring human posture information by identifying a human body in an input video and determining the position and posture of the human body. The function of obtaining the human posture information may be carried out by various conventional or newly developed algorithms, and may be performed by extracting human joint information and joint direction information and then combining them according to an embodiment of the present disclosure.

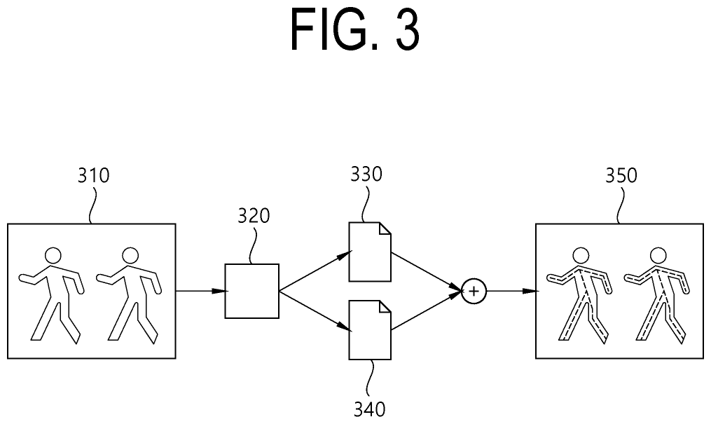

The following description will be provided with reference to FIG. 3 as well. FIG. 3 is a conceptual view of a process of obtaining the human posture information according to an embodiment of the present disclosure. For example, there may be at least one or, in some cases, a plurality of people photographed on an original image 310. The original image 310 may be input to a posture artificial intelligence model 320 and used to generate the human joint information 330 (S230) and the joint direction information 340 (S232). The human joint information 330 may be information related to detecting a human body in the original image 310 and determining the position at which the major joints of the human body exist on the original image 310. The joint direction information 340 may be information indicating each joint is connected to a skeleton in which direction in order to determine which skeleton is present between the main joint parts of the human body shown in the original image 310. Each of the human joint information 330 and the joint direction information 340 may be generated by accumulating a plurality of channels to use spatial information, and, in this case, planar location information on the original image 310 may be included or omitted. The human posture information 350 may be generated by combining the human joint information 330 and the joint direction information 340 at S240. FIG. 3 shows the human posture information 350 in the form of skeletons representing postures overlaid on the original image 310, but this is only exemplary. The information may not actually be generated in the form in which overlaying something else on an image is possible.

According to an embodiment of the present disclosure, the process of generating the human joint information 330 (S230) and the process of generating the joint direction information 340 (S232) may be implemented by the posture artificial intelligence model 320 such as machine learning or an artificial neural network trained by either a supervised learning method or an unsupervised learning method in advance. In addition, according to an embodiment of the present disclosure, the posture artificial intelligence model may be implemented as a convolutional neural network (CNN).

According to an embodiment of the present disclosure, a process of obtaining the original image 310 (S220) and then pre-processing it to generate a frame feature value (S225) may precede inputting the video frame as the original image 310 into the posture artificial intelligence model 320 to generate the human joint information 330 (S230) or the joint direction information 340 (S232). According to an embodiment of the present disclosure, the frame feature value may be the original image 310, that is, video frame data, which is modified to allow the artificial intelligence model 320 to easily learn and process it as an input value.

According to an embodiment of the present disclosure, the human joint information 330 may consist of information about at least one of the face, neck, right shoulder, right elbow, right wrist, left shoulder, left elbow, left wrist, right pelvis, right knee, right ankle, left pelvis, left knee, and left ankle. Since the above-listed joints exist in positions that can be easily identified in a human body and show distinct movements involved in human actions, they may be suitable for detecting abnormal behaviors aimed at in the present disclosure.

In addition, according to an embodiment of the present disclosure, the human joint information 330 may not include information on joints related to the formation of facial expressions, such as the right eye, left eye, right ear, and left ear. The information on the joints related to facial expressions may be included in the human joint information 330 and the joint direction information 340 depending on the type of algorithms and artificial intelligence models. However, since the expression of a person in a filmed video may not be a meaningful detection index in relation to abnormal behaviors sought to be detected in the present disclosure, it may possible to reduce the number of the types of data to be processed by excluding the information about the joints related to facial expressions as described above in order to facilitate training the artificial intelligence model and improve its operating speed.

The obtained human posture information may be used for a process (S202) by the second artificial intelligence. The second artificial intelligence may analyze a specific action taken by the person taking the posture extracted from the human posture information, and, in particular, may have a function for determining whether the person is showing a predetermined abnormal behavior. The function of determining whether an abnormal behavior is being shown based on the human posture information may be carried out by various existing or newly developed algorithms, and may be performed by determining whether a specific abnormal behavior has occurred for a certain period of time by accumulating the human posture information for the certain period of time according to an embodiment of the present disclosure.

The second artificial intelligence may receive at least one piece of the human posture information that is temporally continuous. The temporally continuous posture information may include information about the changing process of a human body posture and may thus act as an important factor in detecting a human behavior. Although there may be no problem in implementing the technology of the present disclosure even when a determination is made based on a single piece of the human posture information extracted from a single video frame, it may be more effective to analyze the changing process of a posture caused by actions occurring for a certain period of time in order to precisely determine the types of large movements that appear in the single frame.

The second artificial intelligence may be implemented as a convolutional long-short-term memory (ConvLSTM) to integrally analyze the temporally continuous posture information.

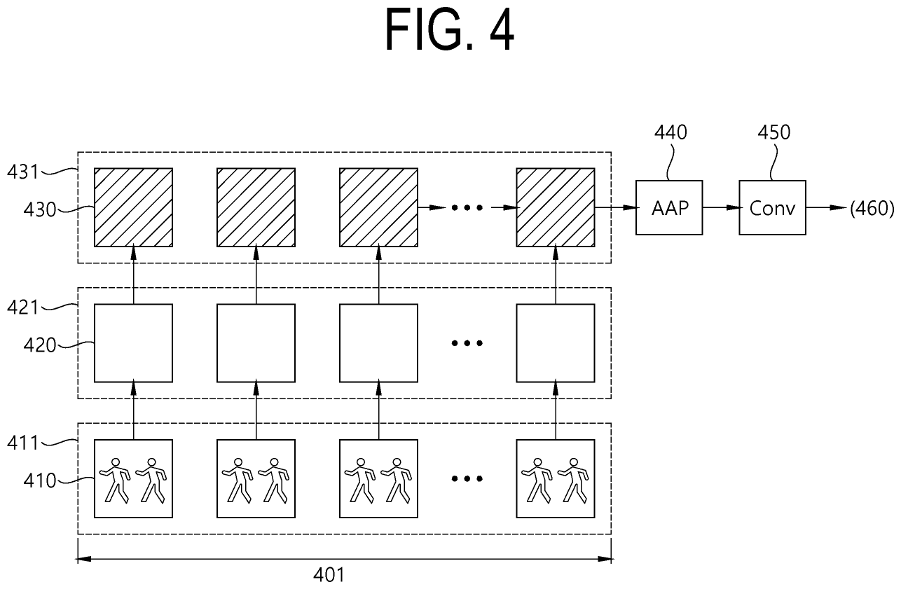

The following description will be made with reference to FIGS. 2 and 4. FIG. 4 is a conceptual view of a process of analyzing the temporally continuous posture information by the ConvLSTM. As described above, the human posture information 420 may be obtained from an input video frame 410 by the first artificial intelligence. The human posture information 420 may be input in a ConvLSTM processing step 430 at S250. In addition, in the ConvLSTM processing step, the human posture information provided for a certain period of time may be accepted. A sequence length 401 of a video frame for analysis by the ConvLSTM may be arbitrarily determined by a person practicing the present disclosure. If the sequence length 401 is N, N piece(s) of the human posture information 421 acquired from N video frame(s) 411 may be sequentially input in the N ConvLSTM processing step(s) 431. The above-mentioned process may be repeated from the step of separating a video frame (S220) until information as much as the sequence length 401 is input (S260).

It can be said that the result of accumulating and repeatedly processing the ConvLSTM as much as the sequence length 401 may include feature values of human behaviors obtained from the video frames 411 provided for the sequence length. From the feature values, information including at least one of whether any behavior exists and the type of the behavior may be obtained, and, in particular, abnormal behavior information including information on the type of the abnormal behavior may be obtained as intended in the present disclosure. In order to facilitate the acquisition process, the result of accumulating and repeatedly processing the ConvLSTM may be simplified based on adaptive average pooling at S270. Furthermore, the result of the adaptive average pooling may be calculated by the convolution at S280, so that it may be used to more easily determine whether or not there is any abnormal behavior detected in the video frames 411 provided for the sequence length.

According to an embodiment of the present disclosure, the result of the calculation by the convolution at S280 may be expressed as a TRUE/FALSE value or a 0/1 value indicating whether a specific abnormal behavior exists or not. According to another embodiment of the present disclosure, the type of an abnormal behavior may be identified by referring to the result of the calculation by the convolution (S280) and the result of the simplification by the adaptive average pooling (S270).

According to the above-mentioned procedure, the second artificial intelligence may obtain and output at least one of information on whether any abnormal behavior exists and information on the abnormal behavior at S290. The information on the abnormal behavior may include, for example, information on at least one of the degree of the abnormal behavior, the severity of the abnormal behavior, the duration of the abnormal behavior, the number of people involved in the abnormal behavior, and the target of the abnormal behavior.

According to an embodiment of the present disclosure, in the procedure by the second artificial intelligence (S202), the process of processing by the ConvLSTM (S260) may be designed to detect a specific type of human behavior, in particular, an abnormal behavior in advance. For example, the second artificial intelligence may be specialized to detect a specific abnormal behavior of “assault” in an input video corresponding to the sequence length. According to an embodiment of the present disclosure, the second artificial intelligence may be designed to detect a plurality of abnormal behaviors such as “assault” and “arson” together. According to another embodiment of the present disclosure, a plurality of artificial intelligence models corresponding to the second artificial intelligence may be used, so that a plurality of abnormal behaviors may be detected by the specialized second artificial intelligences.

In the process of detecting an abnormal behavior shown in FIG. 2 described above, at least one of the abnormal behaviors required to be detected for the fulfillment of the function of the so-called “smart CCTV” may be detected. For example, information on whether at least one of intrusion, loitering, falling down, theft, smoking, and violence has been detected and information on the abnormal behavior may be obtained.

In addition, in the process of detecting an abnormal behavior shown in FIG. 2 described above, an operation for detecting an abnormal behavior may be performed only for one person appearing in the video information and the at least one video frame, or it may be determined for each of a plurality of people whether or not any abnormal behavior has occurred.

The method of detecting an abnormal behavior according to the present disclosure may involve the step of marking the at least one video frame and the corresponding video information based on the information on whether an abnormal behavior has been detected and the information on the abnormal behavior. The marking may be used as information indicating that there is a specific abnormal behavior detected in a corresponding section of an input video.

The marking may be generated as metadata for identifying a corresponding section in the process of processing a video in non-real time. Meanwhile, when a video is being processed in real time, it may be used to generate predetermined alarming information indicating that a problematic situation has been detected in the video being captured. According to an embodiment of the present disclosure, the method of detecting an abnormal behavior according to the present disclosure may be operated in a computer device connected to the CCTV integrated control center, and may be used for the purpose of drawing the attention of a controller by automatically determining whether a person displaying an abnormal behavior is being filmed by a specific CCTV camera.

When the alarming abnormal behavior information is generated based on the marking, it may include at least one of information on a route through which the video frame was obtained, information on the type of the abnormal behavior, and information on the spatial location of the abnormal behavior in the video frame. The information on the route through which the video frame was obtained may include at least one of a unique identifier of the filming equipment, a time at which the video frame was captured, and the geographical location of the filming equipment. In this way, information on which camera at which location detected an abnormal behavior may be included in the alarming information.

The alarming information may be transmitted to a user's terminal and displayed thereon. The transmission method is not limited. Depending on the embodiment, the alarming information may be transmitted to the user's terminal as a software signal or a message generated in the same computing device or server, or as a message transmitted to a separated computing device or terminal through a wired or wireless communication network. In addition, the alarming information may be displayed visually and/or audibly on the user's terminal.

The method according to the present disclosure disclosed through the conceptual view of the process of detecting an abnormal behavior in FIG. 1 and the flow chart of the process of detecting an abnormal behavior in FIG. 2 may be implemented on a computing device and as the same. When the method is implemented as a computing device, it can be classified as a video security monitoring device.

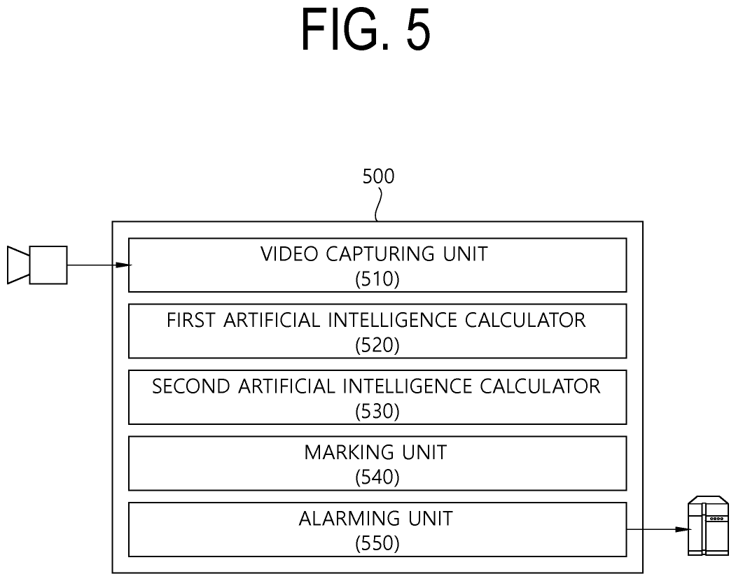

FIG. 5 is a block diagram showing the feature of the video monitoring device according to an embodiment of the present disclosure. The video monitoring device 500 may include a video capturing unit 510 for acquiring at least one video frame, a first artificial intelligence calculator 520 for obtaining information on at least one human body posture based on the acquired video frame, a second artificial intelligence calculator 530 for obtaining information on whether an abnormal behavior has been detected and at least one piece of abnormal behavior information based on at least one piece of information on a human body posture acquired in chronological order, a marking unit 540 for marking the at least one video frame based on the information on whether an abnormal behavior has been detected and the abnormal behavior information, and an alarming unit 550 for generating, based on the marking, alarming information including at least one of information about a route through which the video frame was acquired, information about the type of the abnormal behavior, and information about the spatial location of the abnormal behavior in the video frame and forwarding the alarming information to the manager responsible for dealing with abnormal behaviors.

Although the present disclosure has been described with reference to the drawings and embodiments, as described above, this does not mean that the scope of the present disclosure is limited by the drawings or embodiments above, and it is to be understood by a person having ordinary skill in the technical field that various modifications and variations of the present disclosure are possible within the technology and scope of the present disclosure as set forth in the claims below.

What is claimed is:

1. A method of detecting an abnormal behavior in a video based on a computational device, comprising:
obtaining at least one video frame;
obtaining at least one piece of human posture information from a first artificial intelligence based on the obtained video frame;
obtaining information on whether an abnormal behavior has been detected and at least one piece of abnormal behavior information from a second artificial intelligence based on at least one piece of human posture information obtained in chronological order; and
marking the at least one video frame based on the information on whether an abnormal behavior has been detected and the at least one piece of abnormal behavior information,
wherein the abnormal behavior information includes information on at least one of the degree of the abnormal behavior, the severity of the abnormal behavior, the duration of the abnormal behavior, the number of people involved in the abnormal behavior, and the target of the abnormal behavior.

2. The method of claim 1 further comprising:
generating alarming information on the abnormal behavior based on the marking; and
transmitting the alarming information to a user's terminal,
wherein the alarming information includes at least one of information on a route through which the video frame was acquired, information on the type of the abnormal behavior, and information on the spatial location of the abnormal behavior in the video frame.

3. The method of claim 2, wherein the video frame is taken by a filming equipment including a fixed surveillance camera and a mobile surveillance camera, and the information on the route through which the video frame was acquired includes at least one of a unique identifier of the filming equipment, a time at which the video frame was captured, and the geographical location of the filming equipment.

4. The method of claim 1, wherein the human posture information includes at least one piece of human joint information and at least one piece of joint direction information.

5. The method of claim 4, wherein the human joint information is about at least one of the face, neck, right shoulder, right elbow, right wrist, left shoulder, left elbow, left wrist, right pelvis, right knee, right ankle, left pelvis, left knee, and left ankle.

6. The method of claim 4, wherein the human joint information does not include information on joints related to facial expressions, including the right eye, left eye, right ear, and left ear.

7. The method of claim 4, wherein the first artificial intelligence is designed to receive the video frame, generate the at least one piece of human joint information and the at least one piece of joint direction information based on the video frame, and generate the human posture information by combining the at least one piece of human joint information and the at least one piece of joint direction information.

8. The method of claim 1, wherein the second artificial intelligence is designed to receive the at least one piece of human posture information that is temporally continuous, obtain at least one feature value of an abnormal behavior based on the at least one piece of human posture information, and obtain at least one piece of the information on whether an abnormal behavior has been detected and the abnormal behavior information based on the at least one feature value of the abnormal behavior.

9. The method of claim 8, wherein the second artificial intelligence is formed of a long-short-term memory-based neural network based on convolution, combines the at least one feature value of an abnormal behavior based on a convolution operation, and obtains the information on whether an abnormal behavior has been detected and the abnormal behavior information based on the result of adaptive average pooling on the combined values.

10. The method of claim 8, wherein the second artificial intelligence is designed to obtain information on whether at least one of intrusion, loitering, falling down, theft, smoking, and violence has been detected and information on the abnormal behavior.

11. A video security monitoring device comprising:
a video capturing unit for acquiring at least one video frame;
a memory capable of storing at least one information processing command; and
at least one processor executing the information processing command,
wherein the at least one processor, by executing the information processing command, operates a first artificial intelligence calculator for obtaining at least one piece of human posture information based on the obtained video frame, operates a second artificial intelligence calculator for obtaining information on whether an abnormal behavior has been detected and at least one piece of abnormal behavior information based on at least one piece of human posture information obtained in chronological order, and operates a marking unit for marking the at least one video frame based on the information on whether an abnormal behavior has been detected and the at least one piece of abnormal behavior information, and
the abnormal behavior information includes information on at least one of the degree of the abnormal behavior, the severity of the abnormal behavior, the duration of the abnormal behavior, the number of people involved in the abnormal behavior, and the target of the abnormal behavior.

12. The device of claim 11, wherein the at least one processor, by executing the information processing command, generates alarming information including at least one of information on a route through which the at least one video frame was acquired, information on the type of the abnormal behavior, and information on the spatial location of the abnormal behavior in the video frame, based on the marking, and further operates an alarming unit forwarding the alarming information to the manager responsible for dealing with abnormal behaviors.

13. The device of claim 12, wherein the video capturing unit acquires a video frame by being connected to a filming equipment including a fixed surveillance camera and a mobile surveillance camera, and the information on the route through which the video frame was acquired includes at least one of a unique identifier of the filming equipment, a time at which the video frame was captured, and the geographical location of the filming equipment.

14. The device of claim 11, wherein the human posture information includes at least one piece of human joint information and at least one piece of joint direction information.

15. The device of claim 14, wherein the human joint information is about at least one of the face, neck, right shoulder, right elbow, right wrist, left shoulder, left elbow, left wrist, right pelvis, right knee, right ankle, left pelvis, left knee, and left ankle.

16. The device of claim 14, wherein the human joint information does not include information on joints related to facial expressions, including the right eye, left eye, right ear, and left ear.

17. The device of claim 14, wherein the first artificial intelligence calculator includes a first machine learning model that is operated by the at least one processor, receives the video frame, generates the at least one piece of human joint information and the at least one piece of joint direction information based on the video frame, and generates the human posture information by combining the at least one piece of human joint information and the at least one piece of joint direction information.

18. The device of claim 11, wherein the second artificial intelligence calculator includes a second machine learning model that is operated by the at least one processor, receives the at least one piece of human posture information that is temporally continuous, obtains a feature value of an abnormal behavior based on the at least one piece of human posture information, and obtains the information on whether an abnormal behavior has been detected and the abnormal behavior information based on the feature value of the abnormal behavior.

19. The device of claim 18, wherein the second machine learning model is operated by the at least one processor, is formed of a long-short-term memory-based neural network based on convolution, combines at least one feature value of the abnormal behavior based on a convolution operation, and obtains the information on whether an abnormal behavior has been detected and the abnormal behavior information based on the result of adaptive average pooling on the combined values.

20. The device of claim 18, wherein the second machine learning model is designed to obtain information on whether at least one of intrusion, loitering, falling down, theft, smoking, and violence has been detected and information on the abnormal behavior.
